(19) United States
(12) Patent Application Publication
(10) Pub. No.: US 2023/0394303 A1
(43) Pub. Date: Dec. 7, 2023

(54) MACHINE LEARNING SYSTEM, CLIENT TERMINAL, AGGREGATED SERVER DEVICE AND METHOD

(71) Applicant: KABUSHIKI KAISHA TOSHIBA, Tokyo (JP)

(72) Inventors: Mari MATSUMOTO, Kawasaki (JP); Masanori FURUTA, Odawara (JP)

(73) Assignee: KABUSHIKI KAISHA TOSHIBA, Tokyo (JP)

(21) Appl. No.: 18/179,467

(22) Filed: Mar. 7, 2023

(30) Foreign Application Priority Data
Jun. 3, 2022 (JP) 2022-090740

(51) Int. Cl. G06N 3/08

(52) U.S. Cl. CPC G06N 3/08

(57) ABSTRACT

According to one embodiment, each of the client terminals includes a first processor configured to execute a learning process of machine learning model, extract a first parameter column from the machine learning model, change the arrangement of parameters, perform secret sharing with respect to the first parameter column, and transmit a first fragment parameter column. Each of the aggregated server device includes a second processor configured to receive first fragment parameter columns, change arrangement of fragment parameters, and execute an aggregation process. The machine learning model is updated based on parameters in a second parameter column decoded from second fragment parameter columns generated in the aggregated server devices.

### CROSS-REFERENCE TO RELATED APPLICATIONS

This application is based upon and claims the benefit of priority from Japanese Patent Application No. 2022-090740, filed Jun. 3, 2022, the entire contents of which are incorporated herein by reference.

### FIELD

Embodiments described herein relate generally to a machine learning system, a client terminal, an aggregated server device and a method.

### BACKGROUND

In recent years, advanced telecommunication services using digitized data (information) have been provided. Such telecommunication services make it possible to provide information and other services tailored to the environment based on various data.

By the way, machine learning (learning models generated by machine learning) may be used to realize the provision of telecommunication services described above. The scale of machine learning tends to increase, and in recent years, cloud computing service providers (hereinafter referred to as cloud providers) have been commissioned to perform calculations related to the machine learning to achieve large-scale machine learning.

However, learning data used for machine learning may contain personal information, etc., and when operations related to machine learning are outsourced to cloud providers, the risk of leakage of such learning data arises. Specifically, for example, if machine learning is performed by collecting (aggregating) learning data held by multiple organizations, the learning data may be leaked when collecting the learning data from the multiple organizations, and there is also a possibility that the learning data may be leaked from the aggregated server device.

Federated learning is known as a technique to suppress the leakage of such learning data. The federated learning is a technique to perform the machine learning using learning data across a plurality of organizations, and in the federated learning, for example, a master model (global model) is distributed to each of the multiple organizations, and the master model is learned by each of the multiple organizations using the learning data that is held by each of the multiple organizations. Results of the learning conducted in each of the multiple organizations (differences between the master model before and after updating) are collected by the aggregated server device, and the master model is updated using the collected learning results.

In other words, in federated learning, learning is performed with the learning data distributed without collecting the learning data held in each of the multiple organizations (that is, only the results of the learning are provided to the aggregated server device), thus preventing the leakage of the learning data at the time of learning data collection or the leakage of the learning data collected by the aggregated server device from the aggregated server device.

Furthermore, in federated learning, only the differences between the master model before and after the update (e.g., parameters of the updated master model) are collected by the aggregated server device, which has the further advantage of reducing the amount of communication data when performing machine learning.

However, even if federated learning is applied, it is not possible to eliminate the threat of learning data being estimated from the information collected by the aggregated server device (e.g., parameters obtained in the process of learning), and thus it may not be possible to ensure sufficient security in the event of a leak of such information.

### BRIEF DESCRIPTION OF THE DRAWINGS

FIG. 1 is a diagram illustrating an example of a network structure of a machine learning system of a first embodiment.

FIG. 2 is a diagram illustrating a hardware structure of a client terminal.

FIG. 3 is a diagram illustrating an example of a functional structure of the client terminal.

FIG. 4 is a diagram illustrating an example of a functional structure of an aggregated server device.

FIG. 5 is a sequence chart illustrating an example of a process order of a machine learning system.

FIG. 6 is a diagram illustrating an example of an arrangement changing process.

FIG. 7 is a diagram illustrating a first application example of the machine learning system.

FIG. 8 is a diagram illustrating a second application example of the machine learning system.

FIG. 9 is a diagram illustrating an example of a functional structure of a client terminal of a second embodiment.

FIG. 10 is a sequence chart illustrating an example of a process order of the machine learning system.

FIG. 11 is a diagram illustrating an example of an arrangement changing process of a third embodiment.

### DETAILED DESCRIPTION

In general, according to one embodiment, a machine learning system includes a plurality of client terminals and a plurality of aggregated server devices communicatively connected to the client terminals. Each of the client terminals includes a first processor configured to execute a learning process of machine learning model using learning data managed in the client terminal, extract a first parameter column in which a plurality of parameters are arranged from the machine learning model subjected to the learning process, change the arrangement of the parameters of the extracted first parameter column, perform secret sharing with respect to the first parameter column including the parameters with changed arrangement in order to generate a first fragment parameter column corresponding to each of the aggregated server devices, and transmit the generated first fragment parameter column to the aggregated server devices. Each of the aggregated server devices includes a second processor configured to receive a plurality of first fragment parameter columns transmitted from the client terminals, change arrangement of fragment parameters of each of the received first fragment parameter columns, and execute an aggregation process with respect to the first fragment parameter columns including the fragment parameters with changed arrangement in order to generate a second fragment parameter column. The machine learning model is updated based on a plurality of parameters in a second parameter column decoded from a plurality of second fragment parameter columns generated in the aggregated server devices.

Various embodiments will be described with reference to the accompanying drawings.

### First Embodiment

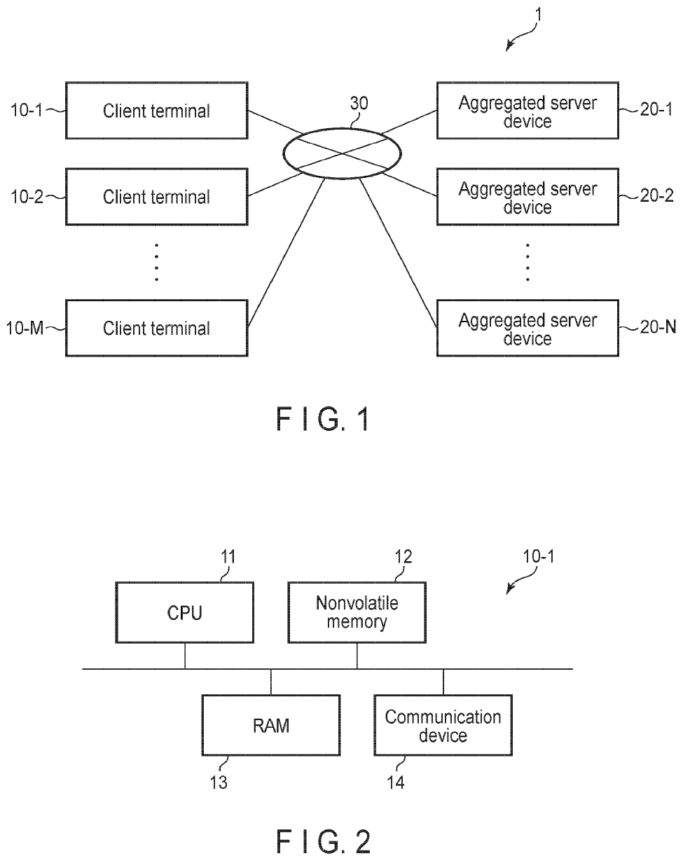

First, the first embodiment will be explained. FIG. 1 illustrates an example of a network structure of a machine learning system of the first embodiment.

A machine learning system 1 of the present embodiment includes a plurality of client terminals and a plurality of aggregated server devices, and is used to perform the machine learning of machine learning model (i.e., to generate machine learning model by machine learning) used to provide various services (telecommunication services).

In the present embodiment, a plurality of client terminals include client terminals 10-1 to 10-M (M is an integer greater than or equal to 2), and a plurality of aggregated server devices include aggregated server devices 20-1 to 20-N (N is an integer greater than or equal to 2).

Each of the client terminals 10-1 to 10-M and the aggregated server devices 20-1 to 20-N is realized by an electronic device (computer) such as a personal computer. Furthermore, the client terminals 10-1 to and the aggregated server devices 20-1 to 20-N are communicatively connected via a network 30 such as the Internet.

Client terminals 10-1 to 10-M are configured to manage (or access) data owned by corresponding organizations (clients), and in the present embodiment, it is supposed that the machine learning of the machine learning model is performed by using the data as learning data. Note that, it is supposed that each of the client terminals 10-1 to 10-M manages different learning data.

Each of the aggregated server devices 20-1 to may be realized as a cloud server device which provides cloud computing services to the client terminals 10-1 to 10-M described above.

The number of client terminals 10-1 to 10-M and the number of aggregated server devices 20-1 to 20-N in the present embodiment may be the same or different.

Here, for example, it is conceivable to collect data (learning data) managed at each of the client terminals 10-1 to 10-M and to perform machine learning using the learning data collected. However, in such a structure, there is a possibility that the learning data may be leaked when collecting learning data from the client terminals 10-1 to 10-M.

In contrast, it may be possible to suppress the above leakage of learning data by applying a technique known as federated learning, for example.

However, in federated learning, it is necessary to collect parameters of the machine learning model obtained by machine learning (updated machine learning model) as a result of learning. If the parameters of the machine learning model are leaked during the collection of the parameters of the machine learning model, the security against leakage of the learning data is not sufficient, because the learning data may be inferred from the parameters.

For this reason, in the present embodiment, a structure to perform, when the machine learning is performed using the learning data managed at each of the client terminals 10-1 to 10-M, keeping the above parameters secret (encrypted).

By the way, there are two types of techniques to achieve the above-mentioned concealment (concealment calculation techniques): quasi-homomorphic cryptography and secret sharing method. Generally, the quasi-homomorphic cryptography requires more calculation load (computing load) as compared to the secret sharing method. For this reason, the secret sharing method is used as the secret operation technique to be applied in the present embodiment.

The secret sharing method is a method for converting data to be concealed (confidential information) into multiple fragments of data which will be referred to as shares, and one of known examples of the secret sharing method is Shamir's secret sharing method.

The following is an overview of Shamir's secret sharing method. In this example, a case where a holder of data a to be secreted securely distributes said data a to n individuals will be considered.

According to the Shamir's secret sharing method, the data holder selects a body (integer ring) Q such that a ∈Q, and secret sharing is performed.

Specifically, k−1 (k is an integer greater than or equal to 2 and less than or equal to n) random sources of body Q, r₁, . . . , rₖ₋₁, and the following formula (1) which is a k−1 degree polynomial with data a to be concealed as intercept is constructed. In other words, r₁, . . . , rₖ₋₁ are random numbers such that r₁, . . . , rₖ₋₁∈Q/qQ. Q/qQ may be constructed as the integers modulo q.

W(P)=Σᵢ₌₁^{k-1}rᵢPⁱ+a Formula (1)

In addition, W (P₁), . . . , W (Pₙ) is calculated by selecting (determining) P₁, . . . , Pₙ, which are the sources of n bodies Q, and by applying said P₁, . . . , Pₙ, respectively, to P in the above formula (1). In other words, P₁, . . . , Pₙ are random numbers such that P₁, . . . , Pₙ∈Q/qQ. Note that r₁, . . . , rₖ₋₁ and P₁, . . . , Pₙ described above correspond to coefficients in the formula (1). In addition, P₁, . . . , and Pₙ are different values. In other words, Pₜ (t=1, 2, . . . , n) is different from Pₜ′ (t′=1, 2, . . . , n, and t≠t′).

W (P₁), . . . , W (Pₙ) calculated as described above are the shares (fragment data) of data a to be secreted and sent to different n server devices, for example.

This allows the data a to be secreted to be distributed to n server devices. Note that, when considered that the n server devices be server devices S₁, . . . , Sₙ and the share sent to server device Sₜ (t=1, 2, . . . , n) be W (Pₜ), said W (Pₜ) is expressed as [a]ₜ: =W (Pₜ), for example.

Next, considered is a case where data a is to be recovered from the n shares distributed as described above. In this case, k server devices (hereinafter denoted as server devices Sₜ₁, . . . , Sₜₖ) are selected from the n server devices S₁, . . . , Sₙ described above, and shares are received from each of the server devices Sₜ₁, . . . , Sₜₖ selected as above. The shares received from server devices Sₜ₁, . . . , Sₜₖ are denoted as [a]ₜ₁, . . . , [a]ₜₖ.

In this case, data a can be recovered from k shares [a]ₜ₁, . . . , [a]ₜₖ by the following formula (2).

a=Σⱼ₌₁^{k}λₜⱼ[a]ₜⱼ Formula (2)

Note that λₜⱼ in formula (2) is a Lagrange coefficient in a Lagrange interpolation method.

According to the Shamir's secret sharing method described above, n shares (fragment data) can be generated (calculated) from a single secret data a, and the n shares can be distributed to n server devices, and at the same time, the original data a (confidential information) can be restored by collecting the shares. In other words, the Shamir's secret sharing method has both loss resistance, in which the original data a can be recovered even if n−k shares are lost, and confidentiality, in which the original data a cannot be recovered from less than k shares, for integers n and k such that k≤n.

In the present embodiment, the learning process of the machine learning model is performed at each of the client terminals 10-1 to 10-M, and the result of the learning process (i.e., parameters of the updated machine learning model) is encrypted (secret) by using the secret sharing method based on Shamir's secret sharing method described above.

In the secret sharing method in the present embodiment, a plurality of aggregated server devices 20-1 to 20-N correspond to the server devices S₁, . . . , Sₙ described above.

The following is a detailed description of the machine learning system 1 of the present embodiment. First, referring to FIG. 2, an example of the hardware structure of client terminal 10-1 among the client terminals 10-1 to 10-M provided with the machine learning system 1 will be described. The hardware structure of client terminal 10-1 is described here for convenience, but each of the other client terminals 10-2 to 10-M has the same hardware structure as shown in FIG. 2.

As shown in FIG. 2, the client terminal 10-1 includes a CPU 11, nonvolatile memory 12, RAM 13, and communication device 14.

The CPU 11 is a processor to control operations of various components within the client terminal 10-1. The CPU 11 may be a single processor or may include multiple processors. The CPU 11 executes various programs loaded from the nonvolatile memory 12 to the RAM 13. These programs include an operating system (OS) and various application programs. The application programs executed by the CPU 11 include programs for operating as a client terminal in the machine learning system 1 (hereinafter referred to as client programs).

The nonvolatile memory 12 is a storage medium used as an auxiliary storage device, and the RAM 13 is a storage medium used as the main storage device. Although only nonvolatile memory 12 and RAM 13 are shown in FIG. 2, the client terminal 10-1 may include other storage devices such as HDD (hard disk drive) and SSD (solid state drive), for example.

The communication device 14 is a device configured to perform communication with devices external to the client terminal 10-1 (e.g., a plurality of aggregated server devices 20-1 to 20-N).

In this example, each of the client terminals 10-1 to 10-M is described as having the hardware structure shown in FIG. 2, and each of the multiple aggregated server devices 20-1 to 20-N of the machine learning system 1 is supposed to have the same hardware structure as the client terminals 10-1 to 10-M.

In each of the client terminals 10-1 to 10-M, the CPU 11 executes the client program, while in each of the aggregated server devices 20-1 to 20-N, the CPU executes server program (used to operate as the aggregated server devices 20-1 to 20-N in the machine learning system 1).

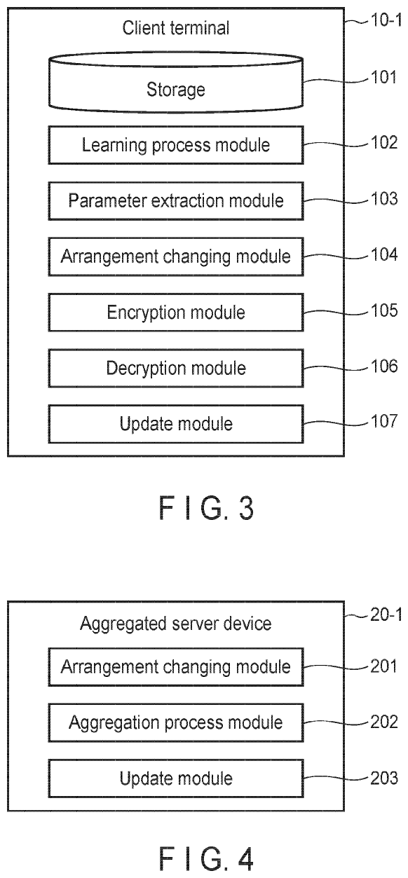

Next, referring to FIG. 3, an example of the functional structure of the client terminal 10-1 among client terminals 10-1 to 10-M will be described. The functional structure of client terminal 10-1 is described here for convenience, but each of the other client terminals 10-2 to 10-M has the same functional structure as shown in FIG. 3.

As in FIG. 3, the client terminal 10-1 includes storage 101, a learning process module 102, a parameter extraction module 103, an arrangement changing module 104, an encryption module 105, a decryption module 106, and an update module 107.

In the present embodiment, the storage 101 included in the client terminal 10-1 is realized by the nonvolatile memory 12 or other storage device shown in FIG. 2.

Part or all of the learning processing module 102, the parameter extraction module 103, the arrangement changing module 104, the encryption module 105, the decryption module 106, and the update module 107 of the client terminal 10-1 shall be realized by having the CPU 11 shown in FIG. 2 (that is, computer of the client terminal 10-1) execute the client program described above, that is, they shall be realized by software. Note that the client program to be executed by the CPU 11 may be stored in a computer-readable storage medium and distributed, or may be downloaded to the client terminal 10-1 through a network.

Although the description here is supposed that each of the modules 102 to 107 is realized by having CPU 11 execute the client program, some or all of the modules 102 to 107 may be realized by hardware such as integrated circuits (ICs), for example, or by a combination of software and hardware.

It is supposed that the storage 101 contains the learning data (data owned by the organization corresponding to the client terminal 10-1).

The learning data stored in the storage 101 may be any data managed by the client terminal 10-1, for example, it is data obtained from a database which can be accessed by the client terminal 10-1. However, the client terminal 10-1 of the present embodiment is arranged in the network structure in which can access the learning data managed by the client terminal 10-1, and cannot access the learning data managed by other clients 10-2 to 10-M. In other words, in the present embodiment, different learning data are stored in the storage 101 in each of the client terminals 10-1 to 10-M.

The learning processing module 102 performs learning processing with respect to the machine learning model (i.e., performs machine learning) using the learning data stored in the storage 101. Note that the machine learning model for which the learning process is performed by the learning processing module 102 is, for example, managed in advance by an external device as a master model, and is distributed to the client terminal 10-1 from the external device. The machine learning model distributed in this manner is maintained in the client terminal 10-1 as a local model, and the learning processing module 102 performs learning processing with respect to the machine learning model (local model).

For example, a neural network will be used as the learning algorithm in the present embodiment. In a neural network, an input layer, an output layer, and one or more intermediate layers (hidden layers) are configured, and multiple nodes in each layer are interconnected with multiple nodes in adjacent layers. The neural network used in the present embodiment may be a convolutional neural network (CNN) or a recurrent neural network (RNN), for example.

Here, the machine learning model of the present embodiment is constructed to output prediction results or analysis results based on the data when, for example, predetermined data is input to provide various services. When the learning process is executed with respect to such a machine learning model, the parameters (network parameters) which constitute the machine learning model are updated. There are multiple parameters for the machine learning model, including, for example, weight coefficients and biases.

The parameter extraction module 103 extracts from the machine learning model a parameter column in which a plurality of parameters constituting the machine learning model for which the learning process has been executed (i.e., a plurality of parameters updated by the execution of the learning process) are arranged in a predetermined order.

The arrangement changing module 104 changes the arrangement of the parameters in the parameter column extracted by the parameter extraction module 103. Changing the parameters in the parameter column includes rearranging the parameters.

The encryption module 105 encrypts the parameter column by performing secret sharing with respect to the parameter column whose arrangement has been changed by the arrangement change module 104. This generates a share column (fragment parameter column) in which the shares of each of the parameters in the parameter column are arranged. As described above, if the machine learning system 1 includes multiple aggregated server devices 20-1 to 20-N (that is, the number of aggregated server devices is N), the encryption module 105 generates N share columns corresponding to each of the aggregated server devices 20-1 to 20-N. Each of the N share columns generated by the encryption unit 105 is sent to the aggregated server device corresponding to the share column among the aggregated server devices 20-1 to 20-N.

The decryption module 106 receives the share column transmitted from each of the aggregated server devices 20-1 to 20-N as described below, and decodes (restores) the parameter column (multiple parameters which constitute the machine learning model) from the received share column. In this case, the client terminal 10-1 receives N share columns from the aggregated server devices 20-1 to 20-N, and according to the Shamir's secret sharing method described above, the number of shares required to restore data is k. Therefore, the decryption module 106 decrypts the parameter column using k of the N share columns received. In this case, k is an integer satisfying 2 or more and N or less (1<k≤N).

The update module 107 applies the parameters in the parameter column decoded by the decryption module 106 to the local model held inside the client terminal 10-1 (i.e., updating the parameters constituting the local model to the parameters in the decoded parameter column) in order to update the local model (machine learning model).

Next, with reference to FIG. 4, an example of the functional structure of aggregated server device among aggregated server devices 20-1 to 20-N will be described. For convenience, aggregated server device 20-1 will be described here, but each of the other aggregated server devices 20-2 to 20-N has the same functional structure as shown in FIG. 4.

As in FIG. 4, the aggregated server device includes an arrangement changing module 201, an aggregation process module 202, and an update module 203.

In the present embodiment, some or all of the arrangement changing module 201, the aggregation process module 202, and the update module 203 in the aggregated server device 20-1 are realized by having the CPU in the aggregated server device 20-1 (that is, computer of the aggregated server device 20-1) execute the server program described above, i.e., by software. Note that the server program to be executed by the CPU may be stored in a computer-readable storage medium and distributed, or may be downloaded to the aggregated server device 20-1 through a network.

Although the description here supposes that each of the modules 201-203 is realized by having the CPU execute the server program, some or all of the modules 201-203 may be realized by hardware, such as ICs, for example, or by a combination of software and hardware.

The arrangement changing module 201 receives M share columns transmitted from each of the client terminals 10-1 to 10-M. As described above, the M share columns sent from each of the client terminals 10-1 to 10-M are data encrypted by secret sharing for the parameter columns which have been rearranged, and the shares for each of the multiple parameters which have been rearranged are arranged in the same order as the multiple parameters in question.

Therefore, for each received share column, the arrangement changing module 201 changes the arrangement of the parameter shares in the share column. Specifically, the arrangement changing module 201 rearranges the shares of the parameters in each of the received M share columns such that they are the same as the arrangement of the parameters in the parameter column at the time when they were extracted from the machine learning model (that is, the order of the parameters before the arrangement is changed by the arrangement changing module 104). Thus, M share columns in which the shares of the same parameter are arranged in the same position (order) can be obtained.

The aggregation process module 202 executes the aggregation process with respect to the M share columns whose sequences have been changed by the arrangement changing module 201. As a result, the aggregation process module 202 generates a single share column in which the M share columns are aggregated. Note that, the share columns aggregated with the M share columns are generated for each of the multiple aggregated server devices 20-1 to 20-N, and such share columns are equivalent to the share columns generated by performing secret sharing with respect to the master model parameter columns (that is, the parameter share columns of the master model).

The update module 203 performs the process of synchronizing the machine learning model (i.e., master model) obtained by machine learning in the machine learning system 1 and the machine learning models held inside the client terminals 10-1 to 10-M (i.e., local models). In this case, the update module 203 sends the share column generated by the aggregation process module 202 (the share column of the master model parameters) to each of the client terminals 10-1 to 10-M. As a result, in each of the client terminals 10-1 to 10-M, the parameter columns can be decoded from k of the N share columns transmitted from each of the aggregated server devices 20-1 to 20-N (update module 203), and the local model can be updated based on the multiple parameters in the decoded parameter columns.

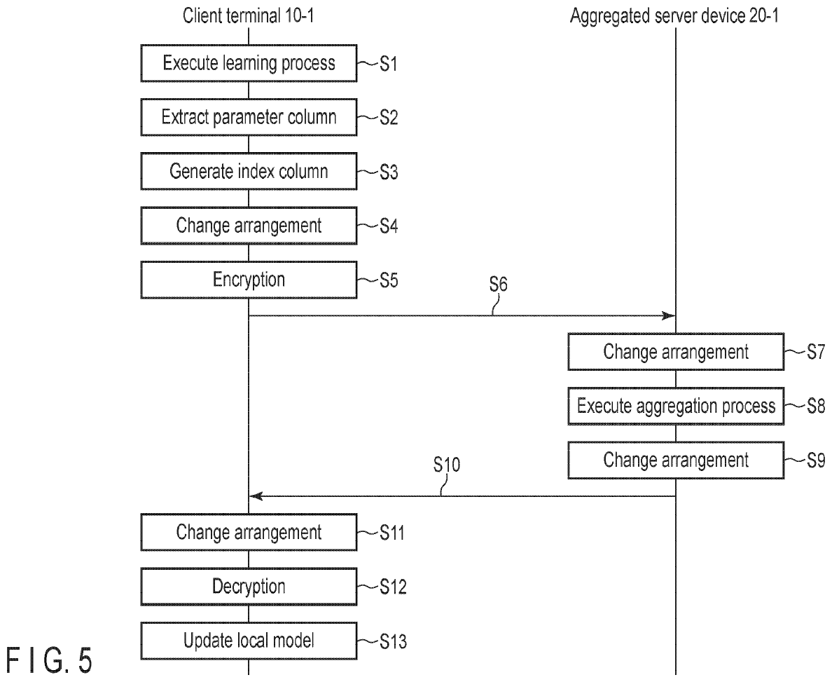

Referring to FIG. 5, an example of the processing procedures of the machine learning system 1 of the present embodiment will be explained. In FIG. 5, only the processes executed at the client terminal 10-1 and the aggregated server device 20-1 are shown, but each of the other client terminals 10-2 to performs the same processing as that of client terminal 10-1 of FIG. 5, and each of the other aggregated server devices 20-2 to 20-N performs the same processing as that of aggregated server device 20-1 of FIG. 5.

In a case where the machine learning is performed in the machine learning system 1 (that is, before the process of FIG. 5 is executed), the master model is distributed to client terminals 10-1 to 10-M in advance, and the master model is retained in the client terminals 10-1 to 10-M as a local model.

In addition, the storage 101 in each of the client terminals 10-1 to 10-M stores the learning data owned by the organization corresponding to the client terminal (learning data managed at the client terminal).

First, the learning processing unit 102 included in the client terminal 10-1 executes the learning process for the local model using the learning data stored in the storage unit 101 included in the client terminal 10-1 (Step S1).

The process of step S1 is described below. In the present embodiment, a plurality of learning data are stored in the storage 101 included in the client terminal 10-1, and each of the learning data includes input data to be input to the machine learning model and data to be output from the machine learning model when the input data is input to the machine learning model (correct data). In step S1, the learning process using each of such learning data is repeatedly executed. Note that, the learning process executes a process in which output data output from the machine learning model (local model) when the input data included in the learning data is input to the machine learning model is compared with the correct data included in the learning data, and parameters of the machine learning model are updated such that the error between the output data and the correct data becomes smaller.

The learning process in step S1 above is set to be terminated when, for example, the accuracy of the machine learning model meets a target value (that is, termination timing of the learning process is adjusted according to the learning accuracy of the machine learning model). The accuracy of the machine learning model is calculated, for example, by using the evaluation data (pairs of input data and correct answer data) prepared in advance and comparing the output data output from the machine learning model and the correct answer data included in the evaluation data. If the calculated accuracy of the machine learning model is equal to or higher than the target value, the process of step S1 (learning process) is terminated, and if the accuracy of the machine learning model is lower than the target value, the learning process is performed again.

Although it is explained here as the accuracy of the machine learning model is calculated using the data for evaluation, for example, the accuracy of the machine learning model may be calculated using part of the multiple learning data stored in the storage 101.

Although it is explained here that the process of step S1 is terminated when the accuracy of the machine learning model meets the target value, the process of step S1 may be terminated when the learning process has been executed for a predetermined number of times (i.e., for a preset number of epochs).

Next, the parameter extraction module 103 extracts the parameter columns from the local model for which the learning process was executed in step S1 (step S2).

Here, when a neural network is used as the learning algorithm of the present embodiment, the local model (machine learning model) includes multiple parameters such as weight coefficients and biases (information). In step S2, a parameter column in which such multiple parameters are arranged in a predetermined order is extracted from the local model. Specifically, for example, a case where the number of parameters of the local model is L and the L parameters are represented as p₁, p₂, . . . , p_{L} is considered, then in step S2, a one-dimensional array of such multiple parameters [p₁, p₂, . . . , p_{L}] is extracted as a parameter column. In the following explanation, the parameter column extracted in step S2 is referred to as first parameter column for convenience.

The process of step S2 is performed at each of the client terminals 10-1 to 10-M. In the parameter columns extracted at each of the client terminals 10-1 to 10-M, the same (same type) parameters are placed in the same position (order).

After the processing of step S2 is executed, the arrangement changing module 104 generates an index sequence in which the indices corresponding to each of the parameters in the first parameter column described above are arranged (step S3). Note that, the index sequence generated in step S3 is assumed to be, for example, an integer sequence of integers representing the order of each of the parameters in the parameter column, and if the first parameter column [p₁, P₂, . . . , p_{L}] is extracted in step S2, an index column [1, 2, . . . , L] is generated in step S3. That is, this index column [1, 2, . . . , L] indicates that the order of the parameter p₁ in the first parameter column [p₁, p₂, . . . , p_{L}] is the first, the order of the parameter p₂ is the second, and the order of the parameter p_{L} is Lth. Note that, the same applies to parameters other than p₁, p₂ and p_{L}.

When the process of step S3 is executed, the arrangement changing module 104 combines the first parameter column extracted in step S2 and the index column generated in said step S3. When the first parameter column [p₁, p₂, . . . , p_{L}] is extracted in step S2 and the index column [1, 2, . . . , L] is generated in step S3 as described above, the first parameter, a 2×L two-dimensional array such as [[1,2, . . . ,L], [p₁, p₂, . . . , p_{L}]] is generated by combining the first parameter column and the index column.

Next, the arrangement changing module 104 changes the arrangement of multiple parameters in the first parameter column (model parameter arrangement) and the arrangement of multiple indices in the index column by randomly replacing the columns in the two-dimensional arrangement generated as described above (Step S4).

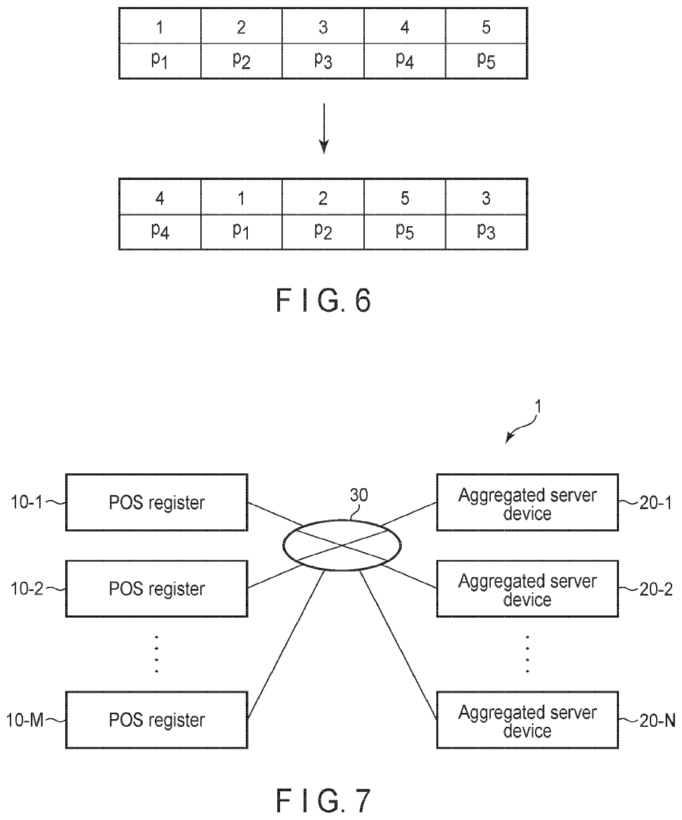

Here, FIG. 6 illustrates an example of the processing of step S4 (arrangement change processing with respect to the first parameter column and index column) described above. In FIG. 6, it is supposed that the first parameter column extracted in step S2 above is [p₁, p₂, p₃, p₄, p₅] and the index column is [1, 2, 3, 4, 5].

In this case, in step S4, the two-dimensional arrangement shown in the upper row of FIG. 6 (two-dimensional arrangement generated by combining the first parameter column and the index column) is converted to the two-dimensional arrangement shown in the lower row of FIG. 6 by randomly replacing the columns in the two-dimensional arrangement.

By separating the first parameter column and the index columns from the two-dimensional arrangement shown in the lower part of FIG. 6, first parameter column [p₄, p₁, p₂, p₅, p₃] the arrangement of multiple parameters of which has been changed from [p₁, p₂, p₃, p₄, p₅], and index column [4, 1, 2, 2, 5, 3] the arrangement of multiple indices of which has been changed from [1, 2, 3, 4, 5] are obtained.

In the present embodiment, the multiple parameters in the first parameter column and the multiple indices in the index column (integers representing the order of each of the multiple parameters in the first parameter column) are rearranged in a state where they correspond to each other (that is, arrangement is changed). Therefore, it can be understood that the rearranged index columns are information (parameter rearrangement information) which shows the correspondence between the arrangement before the change of the parameters in the first parameter column and the arrangement after the change of the parameters in the first parameter column.

The arrangement changing module 104 may, for example, include a random number generator and may be configured to perform the processing in step S4 above using the random numbers generated by the random number generator.

In the present embodiment, the index column is described as an integer sequence in which integers representing the order of each of the parameters in the parameter column are arranged as elements. However, the index column may be an arrangement of other elements as long as it is capable of indicating the correspondence between the arrangement before the change and the arrangement after the change of the aforementioned parameters.

Next, the encryption module 105 encrypts the first parameter column (hereinafter referred to as first parameter column after rearrangement) and the index column (hereinafter referred to as index column after rearrangement) obtained by executing the process of step S4 (step S5). Note that, in the encryption in step S5, the secret sharing described above is performed.

The following describes the case where the first parameter column after rearrangement is encrypted in step S5. In step S5, the secret sharing is performed (that is, using the above formula (1)) to generate N shares from each of the multiple parameters. Specifically, for example, if the first parameter column after rearrangement is [p₄, p₁, p₂, p₅, p₃] of FIG. 6 above, the secret sharing is performed for one parameter p₄ in the first parameter column to generate N shares “p₄₁′, p₄₂′, P_{4N}′” The N shares “p₄₁′, p₄₂′, . . . p_{4N}′” correspond to W (p₁), . . . , W (pₙ) described above. N shares are generated in the same manner with respect to the other parameters “p₁”, “p₂”, “p₅” and “p₅” in the first parameter column after the rearrangement. The detailed explanation of the shares generated by secret sharing is described above, and is omitted here.

The number of shares generated from each of the multiple parameters in the first parameter column after the rearrangement is the same as the number of the aggregated server devices 20-1 to 20-N.

In step S5, the encryption module 105 generates a column of N shares (hereinafter referred to as the first parameter share column) corresponding to each of the aggregated server devices 20-1 to 20-N based on the N shares generated from each of the parameters in the first parameter column after rearrangement as described above.

Specifically, if the first parameter column is [p₄, p₁, p₂, p₅, p₃] as described above, N first parameter share columns corresponding to each of the 20-1 to 20-N aggregated server devices [p₄₁′, p₁₁′, p₂₁′, p₅₁′ p₃₁′], [p₄₂′, p₁₂′, p₂₂′, p₅₂′, p₃₂′], . . . , [p_{4N}′, p_{1N}′, p_{2N}′, p_{5N}′, P_{3N}′] are generated.

Note that “p₁₁′, p₁₂′, . . . , p_{4N}′” are N shares generated by secret sharing for “p₁”, “p₂₁′, p₂₂′, . . . , p_{2N}′” are N shares generated by secret sharing for “p₂”, “p₅₁′, p₅₂′, . . . , p_{5N}′” are N shares generated by secret sharing for “p₅”, and “p₃₁′, p₃₂′, . . . , p_{3N}′” are N shares generated by secret sharing for “p₃”.

The case of encrypting the first parameter column after rearrangement is described here, but the index column after rearrangement is also encrypted in the same way. Specifically, N shares are generated from each of the multiple indices “4”, “1”, “2”, “5” and “3” in the index column after the rearrangement. N share columns (hereafter referred to as index share columns) are generated for each of the aggregated server devices 20-1 through 20-N. In this case, [4₁′, 1₁′, 2₁′, 5₁′, 3₁′], [4₂′, 1₂′, 2₂′, 5₂′, 3₂′], . . . , [4_{N}′, 1_{N}′, 2_{N}′, 5_{N}′, 3_{N}′] as the index share column corresponding to each of the 20-1 to 20-N aggregated server devices. Note that 4₁′, 4₂′, . . . , 4_{N}′ in the index share column represents the N shares generated by secret sharing for the index “4” in the rearranged index column. The detailed explanation is omitted, but the same applies to 1₁′, 1₂′, . . . , 1_{N}′, 2₁′, 2₂′, . . . , 2_{N}′, 5₁′, 5₂′, . . . , 5_{N}′ and 3₁′, 3₂′, . . . , 3_{N}′ in the index share column.

The N first parameter share columns and N index share columns generated by executing the process in step S5 are sent to the aggregated server device 20-1 to 20-N (step S6).

In this case, in step S6, one first parameter share column is sent (distributed) to one aggregated server device. Specifically, for example, for aggregated server device 20-1 among the aggregated server devices 20-1 to 20-N, the first parameter share column [p₄₁′, p₁₁′, p₂₁′, p₅₁′, p₃₁′] is sent. For the other aggregated server devices 20-2 to 20-N, one corresponding first parameter share column is sent in the same way.

Although the first parameter share column is described here, the same applies to the index share column. That is, for aggregated server device 20-1 among aggregated server devices 20-1 to 20-N, the index share columns [4₁′, 1₁′, 2₁′, 5₁′, 3₁′] are sent. For the other aggregated server devices 20-2 to 20-N, one corresponding index share column is sent in the same way.

In the present embodiment, the first parameter share column and the index share column are sent in different files.

The arrangement changing module 201 in the aggregated server device 20-1 receives the parameter share column and index share column sent from the client terminal 10-1 in step S6. Since the above steps S1 to S6 are also executed at each of the other client terminals 10-2 to 10-M, as a result, the arrangement changing module 201 receives M first parameter share columns and M index share columns transmitted from each of the client terminals 10-1 to 10-M.

Here, for example, in the first parameter share column received from the client terminal 10-1, the parameter shares are arranged, but the arrangement (order) of the parameters in the first parameter column in the first parameter column used to generate the first parameter share column has been changed by the execution of step S4 in the client terminal 10-1. Since this change of arrangement (rearrangement of multiple parameters) is performed randomly at each of the client terminals 10-1 to 10-M, the arrangement (i.e., rearrangement order) of the multiple parameters (shares) is different between the client terminals 10-1 to 10-M. In other words, for example, the (arrangement of) parameter shares in the first parameter share column received from the client terminal 10-1 does not correspond to the (arrangement of) parameter shares in the first parameter share column received from other client terminals 10-2 to 10-M.

Therefore, for each client terminal 10-1 to the arrangement changing module 201 changes the arrangement of multiple parameter shares in the first parameter share column based on the index share column (step S7).

Here, for example, considered is a case where the first parameter share column [p₄₁′, p₁₁′, p₂₁′, p₅₁′, p₃₁′] and the index share column [4₁′, 1₁′, 2₁′, 5₁′, 3₁′] are received from client terminal 10-1. As described above, the first parameter share column and the index share column are sent in different files, but the file containing the first parameter share column and the file containing the index share column are each marked with information to identify (specify) the client terminal from which the file was sent (e.g., terminal ID, etc.). By referring to the information attached to such files, the arrangement changing module 201 identifies (determines) the first parameter share column and the index share column sent from the same client terminal (e.g., client terminal 10-1) from M parameter share columns and M index share columns received by the aggregated server device 20-1.

In this case, the arrangement changing module 201 rearranges the columns in the 2×5 two-dimensional arrangement [[4₁′, 1₁′, 2₁′, 5₁′, 3₁′], [p₄₁′, p₁₁′, p₂₁′, p₅₁′, p₃₁′]] in which the first parameter share column [p₄₁′, p₁₁′, p₂₁′, p₅₁′, p₃₁′] and the index share column [4₁′, 1₁′, 2₁′, 5₁′, 3₁′] are combined based on the index share columns (arrangement of multiple index shares therein). According to the above, the above two-dimensional arrangement [[4₁′, 1₁′, 2₁′, 5₁′, 3₁′], [p₄₁′, p₁₁′, p₂₁′, p₅₁′, p₃₁′]] is converted into a two-dimensional arrangement [[1₁′, 2₁′, 3₁′, 4₁′, 5₁′], [p₁₁′, p₂₁′, p₃₁′, p₄₁′, p₅₁]] (in other words, the conversion is the reverse of FIG. 6 above and the data are sorted based on the index column while being encrypted). The first parameter share column [p₁₁′, p₂₁′, p₃₁′, p₄₁′, p₅₁] is obtained from the two-dimensional arrangement [[1₁′, 2₁′, 3₁′, 4₁′, 5₁′], [p₁₁′, p₂₁′, p₃₁′, p₄₁′, p₅₁]] converted in the above manner.

In step S7, the multiple parameter shares in the first parameter share column are rearranged (i.e., sorted) according to the arrangement of the multiple index shares in the index share column as described above, such that the first parameter share column in which the shares of the parameters are arranged in the correct order before the rearrangement can be obtained.

Although the case of changing the arrangement of multiple parameter shares in the first parameter share column received from client terminal 10-1 is described here, the arrangement changing module 201 changes the arrangement of multiple parameter shares in the first parameter share column with respect to (first parameter columns received from) other client terminals 10-2 to 10-M in the same manner. According to this, the arrangement changing module 201 in the aggregated server device 20-1 changes the M first parameter share columns corresponding to each of the client terminals 10-1 to 10-M [p₁₁′, p₂₁′, p₃₁′, p₄₁′, p₅₁]. Note that since the learning process using different learning data is executed at each of the client terminals 10-1 to 10-M, the values of the shares of each parameter (i.e., parameters of the local model) in the first parameter share column [p₁₁′, p₂₁′, p₃₁′, p₄₁′, p₅₁] corresponding to each of the client terminals 10-1 to are different for each client terminal 10-1 to 10-M.

By the way, in order to change the arrangement of multiple parameter shares in the first parameter share column, it is necessary to refer to the index share column (the arrangement of multiple index shares in the index share column), but the index shares are, as mentioned above, the encrypted data of the multiple indices in the index column. For this reason, the process in step S7 above (the operation to rearrange the shares of the parameters in the first parameter share column) shall be performed by a technique called secure calculation, which is capable of calculating data in encrypted form. In other words, in the present embodiment, secure calculation can be used to rearrange the shares of multiple parameters in the first parameter share column (i.e., change the arrangement) without decrypting the index share column.

Next, the aggregation process module 202 executes the aggregation process for the M first parameter share columns corresponding to each of the client terminals 10-1 to 10-M obtained by executing the process of step S7 (step S8). The aggregation process is a process to generate a single parameter share column (hereinafter referred to as second parameter share column) from the M first parameter share columns by aggregating, for example, the parameter shares located at the same position (order) in each of the M first parameter share columns.

Specifically, for example, if M first parameter share columns [p₁₁′, p₂₁′, p₃₁′, p₄₁′, p₅₁] corresponding to each of the client terminals 10-1 to have been obtained in the aggregated server device the parameter shares p₁₁′ in each of the first parameter share columns are aggregated together, the shares of the parameter p₂₁′ in each of such parameter share columns are aggregated with each other, the shares of the parameter p₃₁′ in each of such parameter share columns are aggregated with each other, the shares of the parameter p₄₁′ in each of the share columns of the parameter are aggregated with each other, the shares of the parameter p₅₁′ in each of the share columns of the parameter are aggregated with each other. This produces a second parameter share column in which the result of the aggregation of the parameter shares p₁₁′, the aggregation of the parameter shares p₂₁′, the aggregation of the parameter shares p₃₁′, the aggregation of the parameter shares p₄₁′, and the aggregation of the parameter shares p₅₁′ are arranged.

The aggregation (processing) of the present embodiment may be any process which aggregates multiple data (shares) into a single data, such as averaging.

The parameter shares to be aggregated in the aggregation process executed in step S8 are the encrypted data of each of the multiple parameters in the first parameter column as described above. Therefore, the process of step S8 (aggregation process) shall be performed by the secure calculation described above.

After the processing of step S8 is executed, the arrangement changing module 201 changes the arrangement of the parameter shares in the second parameter share column generated by the execution of step S8 (step S9). In step S9, by changing (rearranging) the arrangement of multiple parameter shares for each of the client terminals 10-1 to 10-M based on the index share column (i.e., the order of the indices) received from each of the client terminals 10-1 to 10-M in step 6, the second parameter share column corresponding to each of the client terminals 10-1 to 10-M is obtained.

Specifically, for example, if the second parameter share column generated by the execution of step S8 is [p₁₁′, p₂₁′, p₃₁′, p₄₁′, p₅₁], and the index share column received from the client terminal 10-1 of the client terminals 10-1 to 10-M is [4₁′, 1₁′, 21′, 5₁′, 3₁′], the arrangement changing module 201 obtains the second parameter share column [p₄₁′, p₁₁′, p₂₁′, p₅₁′, p₃₁′] corresponding to the client terminal 1-1. Furthermore, if the index share column received from the client terminal 10-2 is [2₁′, 5₁′, 1₁′, 4₁′, 3₁′], the arrangement changing module 201 obtains the second parameter share column [p₂₁′, p₅₁′, p₁₁′, p₄₁′, p₃₁′] corresponding to the second parameter 10-2. In this example, the second parameter share column corresponding to each of client terminals 10-1 and 10-2 is described, but the second parameter share column corresponding to each of the other client terminals 10-3 to 10-M will be obtained in the same manner.

The update module 203 sends the second parameter share column obtained by executing the process of step S9 as described above to the client terminals 10-1 to 10-M (step S10). In this case, among the M second parameter share columns corresponding to each of the client terminals 10-1 to 10-M obtained by executing the process of step S9 as described above, for example, the second parameter share column [p₄₁′, p₁₁′, p₂₁′, p₅₁′, p₃₁′] corresponding to the client terminal 10-1 is sent to the client terminal 10-1. Similarly, the second parameter share column [p₂₁′, p₅₁′, p₁₁′, p₄₁′, p₃₁′] corresponding to the client terminal 10-2 is sent to the client terminal 10-2. Although the second parameter share columns sent to client terminals 10-1 and 10-2 are described here, the second parameter share columns are also sent to the other client terminals 10-3 to 10-M in the same manner.

The client terminal 10-1 receives the second parameter share column transmitted in step S10, and the arrangement changing module 104 in the client terminal changes the arrangement of the parameter shares in the second parameter share column (step S11).

For example, if a second parameter share column [p₄₁′, p₁₁′, p₂₁′, p₅′, p₃₁] is received at the client terminal 10-1, the arrangement changing module 201 changes the arrangement of the parameter shares in the second parameter share column based on the index sequence [4, 1, 2, 5, 3] (i.e., the rearrangement information of the plaintext parameters held in the client terminal 10-1) in order to obtain the second parameter share column [p₁₁′, p₂₁′, p₃₁′, p₄₁′, p₅₁′].

Here, since the above step S10 is performed by each of the aggregated server devices 20-1 to 20-N, for example, the client terminal 10-1 receives N second parameter share columns sent from each of the aggregated server devices 20-1 to 20-N. The processing of step S11 is performed for each of the N second parameter share columns.

In this case, since each of the N second parameter share columns obtained by executing the process of step S11 can be regarded as a share value for the master model in plaintext (i.e., a master model parameter share column), the decryption module 106 decrypts a parameter column (hereinafter referred to as second parameter column) from the N second parameter share columns (step S12).

In step S12, by using the above formula (2), the decoding process of k parameter shares arranged in the same position (order) in each of the k second parameter share columns selected from the N second parameter share columns obtained by executing the process in step S11 is sequentially executed, and thus, a second parameter column in which the decoded parameters are arranged in order is generated.

After the processing of step S12 is performed, by applying the parameters in the second parameter column generated by the processing of step S12 to a local model retained within the client terminal 10-1, the update module 107 updates the local model (step S13).

Although the arrangement (order) of the parameter shares in the second parameter share column transmitted in step S10 above is different, the processes in steps S11 to S13 are performed at each of the client terminals 10-1 to 10-M. Therefore, the local model (machine learning model) after step S13 is executed at each of the client terminals 10-1 to 10-M is the same.

In other words, in the present embodiment, by executing the above step S13 at each of the client terminals 10-1 to 10-M, the machine learning model (master model) obtained by the machine learning performed in the machine learning system 1 as a whole and the machine learning model (local model updated in step S13) held inside each of the client terminals 10-1 to 10-M are synchronized.

In the present embodiment, the process of FIG. 5 is repeatedly executed to perform the machine learning using learning data which is distributed and managed at each of the client terminals 10-1 to 10-M.

In the example of FIG. 5, it is explained that step S12 is executed after step S11 is executed; however, in the process shown in FIG. 5, for example, step S12 may be executed before step S11 is executed (i.e., the order of steps S11 and S12 in FIG. 5 may be switched).

In the example of FIG. 5, steps S11 to S13 are described as being executed at client terminals 10-1 to 10-M in order to continuously perform machine learning in the machine learning system 1. However, the processes corresponding to steps S11 to S13 may be executed by a device different from the client terminals 10-1 to 10-M. Specifically, the processes corresponding to steps S11 to S13 may be executed by a device located outside the machine learning system 1 (such as a device which provides services using the machine learning model), for example. In other words, when the machine learning is to be terminated, the process related to updating the machine learning model may be executed by a device other than the client terminals 10-1 to 10-M.

In the present embodiment, as described above, each of the client terminals 10-1 to 10-M performs the training process of the machine learning model using the learning data managed by the client terminal, extracts the first parameter column in which multiple parameters are arranged from the machine learning model for which the training process has been executed, changes the arrangement of multiple parameters in the extracted first parameter column, and executing secret sharing with respect to the first parameter column in which the arrangement of the multiple parameters has been changed, in order to generate first parameter share column (first fragment parameter column) corresponding to each of the aggregated server device 20-1 to 20-N and to transmit the generated first parameter share column to each of the aggregated server devices 20-1 to 20-N. Furthermore, in the present embodiment, each of the aggregated server devices 20-1 to 20-N receives M first parameter share columns sent from each of the client terminals 10-1 to 10-M, changes the arrangement of the parameter shares in each of the received M first parameter share columns, and executes the aggregation process with respect to the M first parameter share columns in which the arrangement of the parameter shares has been changed in order to generate a second parameter share column (second fragment parameter column). In the present embodiment, the machine learning model is updated based on the multiple parameters in the second parameter column decoded from the N second parameter share columns generated in each of the aggregated server devices 20-1 to 20-N.

In the present embodiment, the above structure enables a high level of security in the machine learning (federated learning).

Specifically, in the present embodiment, the first parameter share column generated by secret sharing is sent from the client terminals 10-1 to 10-M to the aggregated server device 20-1 to 20-N, thereby preventing such a possibility that parameters (columns) are obtained by a third party during the communication between the client terminals 10-1 to 10-M and the aggregated server devices 20-1 to 20-N and learning data are inferred from the parameters (that is, learning data is leaked).

The secret sharing in the present embodiment is achieved by determining the first coefficients r₁, . . . , rₖ₋₁, which are the sources of k−1 random integer rings Q, and the second coefficients P₁, . . . . , P_{N}, which are the sources of N random integer rings Q for each of aggregated server devices 20-1 to 20-N, and based on the first order polynomial (Formula (1) above), generating N first parameter share columns corresponding to each of the 20-1 to 20-N aggregated server devices, and then transmitting the generated N first parameter share columns to the aggregated server device corresponding to the share columns converts each of the generated N first parameter share columns into the relevant first parameter share column.

By the way, even in a structure where secret sharing is implemented as above, if, for example, k first parameter share columns among N first parameter share columns are obtained by a third party, there is a possibility that the parameter columns are decoded from the k first parameter share columns and the learning data are inferred from the parameter columns (multiple parameters therein).

However, in the present embodiment, since the secret sharing is performed after changing the sequence of multiple parameters, even if a parameter column is decrypted from the k first parameter share columns as above, the multiple parameters (decoded data) cannot function as correct model information because the correct order of the multiple parameters in the parameter column is unknown (i.e., they cannot be used as multiple parameters which constitute the machine learning model). In other words, in the present embodiment, the sorting process must be performed after obtaining the correct combination of the first parameter share column and the index share column indicating the arrangement order thereof from each of the client terminals 10-1 to 10-M, and thus, the difficulty of guessing the learning data described above is considered to be improved.

In other words, in the present embodiment, as described above, secret sharing and changing the arrangement of multiple parameters in the parameter column are applied in the federative learning process to achieve a high level of security against leakage of learning data, etc.

Note that, in the present embodiment, the structure in which the aggregation process is executed by secure calculation makes it possible to aggregate the first parameter share column transmitted from each of the client terminals 10-1 to 10-M without decoding the first parameter column, which further improves the security.

Furthermore, in the present embodiment, each of the client terminals 10-1 to 10-M performs the secret sharing with respect to the index column indicative of the correspondence between the arrangement of multiple parameters in the first parameter column (first arrangement) and the arrangement of multiple parameters which have been changed from the first arrangement (second arrangement) (i.e., the index column after the arrangement change) in order to generate an index share column corresponding to each of the aggregated sever devices 20-1 to 20-N (fragment index column), and transmits the generated index share column to each of the aggregated server devices 20-1 to 20-N. In the present embodiment, each of the aggregated server devices 20-1 to 20-N receives M index share columns sent from each of the client terminals 10-1 to 10-M, and based on each of the received M index share columns, changes the arrangement of a plurality of parameter shares in each of the M first parameter share columns.

In the present embodiment, with such a structure, it is possible to unify the order of the multiple parameters in the M first parameter share columns which have been randomly sorted (rearranged) in each of the client terminals 10-1 to 10-M, and to aggregate the M first parameter share columns appropriately.

In the present embodiment, for example, by adopting a structure in which the first parameter share column and the index share column are sent from client terminals 10-1 to 10-M to aggregated server devices 20-1 to 20-N in different files, the index share column is obtained together with the first parameter share column, the multiple parameters (arrangements thereof) in the parameter column decoded from the first parameter share column are prevented from being sorted in the correct order.

Furthermore, in the present embodiment, a change of the arrangement of the parameter shares in the first parameter share column based on the index share column described above (i.e., rearrangement operation) is supposed to be performed by secure calculation. According to the above, the process of decoding the index column from the index share column is unnecessary, and thus the amount of processing in each of the aggregated server devices 20-1 to 20-N can be reduced.

In the present embodiment, the second parameter share column is sent from the aggregated server devices 20-1 to 20-N to the client terminals 10-1 to 10-M, and the change of the arrangement of multiple parameter shares in the second parameter share column is performed based on the index column (rearrangement information of parameters in plaintext) held at each of the client terminals 10-1 to 10-M, and thus, the index share column does not need to be sent from the aggregated server device 20-1 to 20-N to client terminals 10-1 to 10-M. With such a structure, even if the second parameter share column is acquired by a third party and the second parameter column is decrypted from the second parameter share column, the rearrangement of multiple parameters in the second parameter column cannot be performed (i.e. index share column cannot be obtained), and this reduces the risk of leakage of learning data as described above. In addition, if the rearrangement information of the plaintext parameters described above is discarded (not held) at the client terminals 10-1 to 10-M, the aggregated server devices 20-1 to 20-N may send the index share columns corresponding to each of the client terminals 10-1 to 10-M together with the second parameter share column to the client terminals 10-1 to 10-M. In this case, the second parameter share column and the index share column are sent in different files.

Although the present embodiment is described above as applying both secret sharing and changing of the arrangement of multiple parameters in the parameter column, the present embodiment may adopt a structure in which only secret sharing is applied and the changing of the arrangement of multiple parameters in the parameter column may be omitted. In this case, steps S3, S4, S7, S9 and S11 of FIG. 5 can be omitted.

The following is a brief description of the application examples of the machine learning system 1 of the present embodiment. Here, the first and second application examples of the machine learning system 1 will be explained.

As in FIG. 7, in the first application example, it is supposed that, for example, each of the client terminals 10-1 to 10-M is a POS cash register installed in a store such as a convenience store. In this first application example, the machine learning is performed using information about the store in which the POS cash register is installed and purchase information collected at the POS cash register as learning data to obtain a machine learning model to provide services such as predicting (analyzing) sales at a new store or predicting (analyzing) the customer base which will purchase new products.

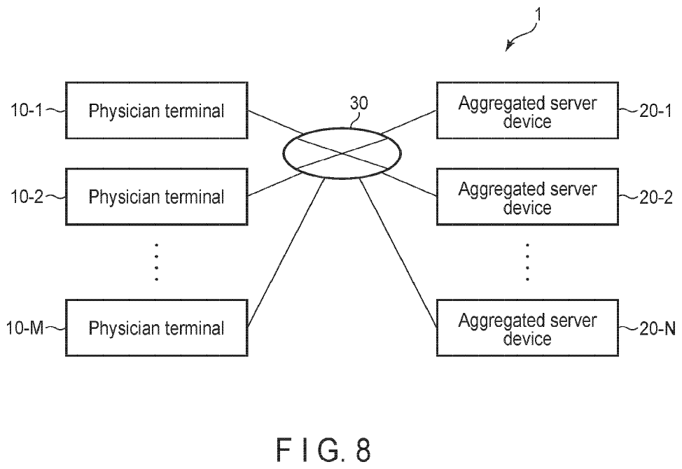

Furthermore, as in FIG. 8, in the second application example, it is supposed that, for example, each of the client terminals 10-1 to 10-M is a terminal device such as a personal computer located in a medical institution such as a hospital and used by a physician or the like (hereinafter referred to as physician terminal). In such a second application example, a machine learning model which can predict (analyze) risks which may occur to patients (e.g., medical conditions which may develop in the future) by using information about patients (information from electronic medical records) input into the physician terminal as learning data can be obtained.

The first and second application examples described here are examples, and the machine learning system 1 of the present embodiment can be applied to various fields as long as the machine learning is performed using learning data which is distributed and managed in each of the client terminals 10-1 to 10-M.

### Second Embodiment

Next, the second embodiment is described. The network structure of the machine learning system of the present embodiment and the hardware structure of the client terminal and aggregated server device provided in the machine learning system are similar to those of the aforementioned first embodiment. Thus, a detailed explanation will be omitted here. The present embodiment differs from the aforementioned first embodiment mainly in the following point.

The present embodiment differs from the aforementioned first embodiment in that it has a structure for evaluating the machine learning model (accuracy of the machine learning model) obtained by machine learning being performed.

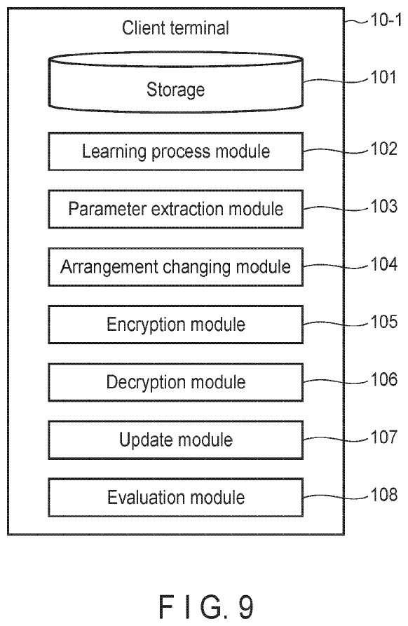

Referring to FIG. 9, an example of the functional structure of the client terminal 10-1 of the present embodiment is described here. The functional structure of the client terminal 10-1 is described here for convenience, but each of the other client terminals 10-2 to 10-M has the same functional structure as shown in FIG. 9.

As shown in FIG. 9, the client terminal 10-1 further includes an evaluation module 108 in addition to the storage 101, the learning process module 102, the parameter extraction module 103, the arrangement changing module 104, the encryption module 105, the decryption module 106 and the update module 107 shown in FIG. 3 above.

Some or all of the evaluation module 108 may be realized by software, by hardware, or by a combination of software and hardware.

The evaluation module 108 evaluates the machine learning model updated by the update module 107. Based on the results of evaluation of the machine learning model performed by the evaluation module 108, the learning process of the machine learning model is executed again (i.e., machine learning is performed repeatedly).

The functional structure of the aggregated server devices 20-1 to 20-N is the same as that of the aforementioned first embodiment, and thus, a detailed description is omitted here and FIG. 4 will be used as appropriate.

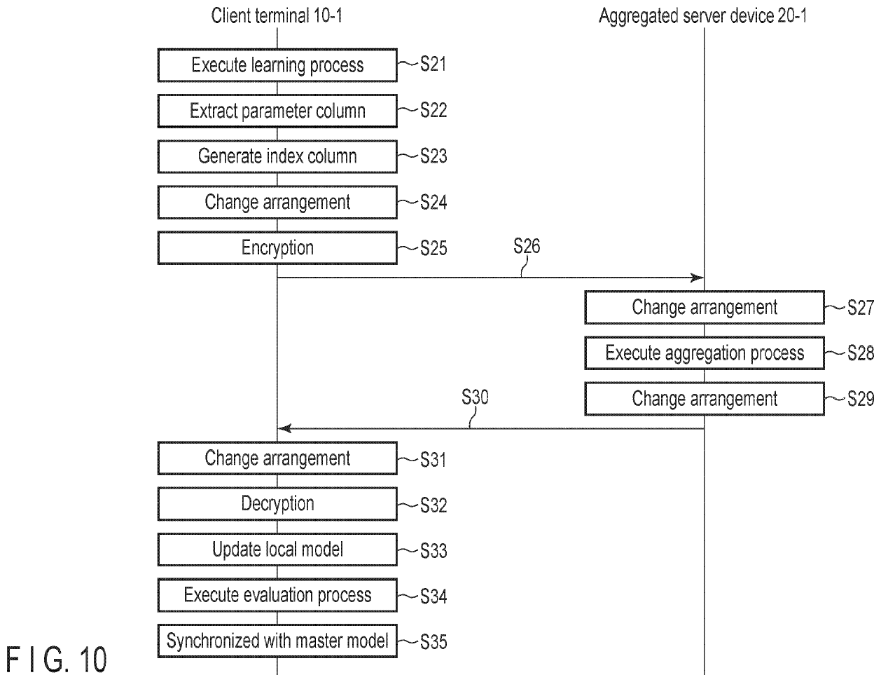

An example of a processing procedure of the machine learning system 1 of the present embodiment will be explained below, referring to the sequence chart of FIG. 10. In FIG. 10, only the processes executed at client terminal 10-1 and aggregated server device 20-1 are shown, but other client terminals 10-2 to 10-M perform the same processing as that of client terminal 10-1 shown in FIG. 9, and each of the other aggregated server devices 20-2 to 20-N performs the same processing as shown in FIG. 9.

First, steps S21 to S33, which correspond to steps S1 to S13 of FIG. 5 above, are performed. The local model updated in step S33 corresponds to the machine learning model (hereinafter referred to as first master model) obtained by machine learning in the entire machine learning system 1.

The process shown in FIG. 10 is executed with the previously distributed master model retained in the client terminal 10-1 (to 10-M) as a local model, in the same manner as the process shown in FIG. 5 above, but the master model (i.e., the master model before the process shown in FIG. 10 is executed) is referred to as second master model for convenience.

Here, the evaluation module 108 in the client terminal 10-1 executes the process of evaluating the first master model (local model updated at the client terminal 10-1) described above (hereinafter referred to as evaluation process) (step S34).

Specifically, in step S34, the accuracy of the first master model is calculated. Note that, the accuracy of the first master model (machine learning model) is calculated, as described in the aforementioned first embodiment, using a preset evaluation data (pairs of input data and output data), for example, based on a difference between the output data output from a first master model when the input data is input to the first master model and the correct data. Note that, by using multiple pairs of input data and correct data, the accuracy of the first master model may be calculated as the percentage of correct answers when a difference between the output data and the correct data is within a predefined range.

After the processing of step S34 is executed, the evaluation module 108 selects one of the first and second master models described above based on the result of the processing of step S34 (i.e., evaluation result), and synchronizes the local model held inside the client terminal 10-1 with the selected master model (step S35).

In this case, the evaluation module 108 compares the accuracy of the first master model calculated by executing the process of step S34 with the target value and determines whether the accuracy of the first master model is greater than or equal to the target value.

If it is determined that the accuracy of the first master model is equal to or greater than the target value, the evaluation module 108 selects the first master model (i.e., new machine learning model updated in step S33) and synchronizes the local model with the said first master model (i.e., the first master model is retained in the client terminal 10-1 as the local model).

On the other hand, if it is determined that the accuracy of the first master model is not greater than or equal to the target value (i.e., less than the target value), the evaluation module 108 selects a second master model (i.e., master model at the time the process shown in FIG. 10 is executed) and synchronizes the local model with that second master model (i.e. maintain the second master model as the local model).

In other words, in the machine learning repeatedly performed in the machine learning system 1 of the present embodiment, if the evaluation result (accuracy) of the first master model is greater than or equal to the target value, the learning process of the first master model (updated machine learning model) is performed again as in the aforementioned first embodiment. If the evaluation result (accuracy) of the first master model is not greater than or equal to the target value, the learning process of the second master model (machine learning model before being updated) is performed again. In this case, the learning process may use the same learning data as the learning data used in the previous training process. However, Part or all of the learning data may be different from the learning data used in the previous training process. Furthermore, the data for evaluation used to calculate the accuracy of the first master model described above shall be different for each of the client terminals 10-1 to 10-M (i.e., individually prepared). As the data for evaluation, a portion of the learning data stored in the storage 101 included in each of the client terminals 10-1 to 10-M may be used. Furthermore, the target value used in selecting the first or second master model described above may be a value common to the client terminals 10-1 to 10-M, or it may be a value which differs for each of the client terminals 10-1 to 10-M. In other words, in the present embodiment, the local model may be synchronized with the first master model in some of the client terminals 10-1 to 10-M, and the local model may be synchronized with the second master model in others.

As described above, in the present embodiment, for example, the first master model (machine learning model after being updated) is evaluated using evaluation data prepared in advance, and based on the evaluation results, the learning process of the first master model or the second master model (machine learning model before being updated) is executed. In the present embodiment, with such a structure, if the first master model is not accurate enough, the first master model is not used (i.e., the updated machine learning model is not used), and therefore, the accuracy of the machine learning model (master model) obtained by machine learning in the machine learning system 1 can be improved.

### Third Embodiment

Next, the third embodiment is described. The network structure of the machine learning system of the present embodiment, the hardware structure of the client terminal and the aggregated server device provided in the machine learning system, and the functional structure are the same as those of the first embodiment described above. Thus, a detailed explanation is omitted here. The present embodiment differs from the aforementioned first embodiment mainly in the following point.

Here, in the aforementioned first embodiment, it is explained that the first parameter share column and index share column are sent from the client terminals 10-1 to 10-M to the aggregated server devices 20-1 to 20-N; however, if k first parameter share columns among the N first parameter share columns sent from each of the client terminals 10-1 to 10-M to the aggregated server device 20-N are acquired by a third party, and k index share columns among the N index share columns are acquired by a third party, then the first parameter column in which the multiple parameters have been rearranged in a correct order may be decoded from the k first parameter share columns and k index share columns, and there is a possibility that the learning data used in the training process of the learning model (local model) from which the first parameter column was extracted may be inferred.

In contrast, the present embodiment differs from the aforementioned first embodiment in that it prepares (generates) a dummy index column in addition to the index column (index share column) in the aforementioned first embodiment.

The following is an example of a processing procedure of the machine learning system 1 of the present embodiment. For convenience, above-mentioned FIG. 5 will be referred in this example.

First, steps S1 and S2 are performed as described above. Next, in the first embodiment described above, a single index column is generated, in which indices corresponding to each of multiple parameters in the first parameter column are arranged. In the present embodiment, the arrangement changing module 104 generates multiple index columns (hereinafter referred to as first and second index columns) (step S3). Specifically, for example, if the number of parameters in the first parameter column is L as explained in the first embodiment above, in the present embodiment, the arrangement changing module 104 generates, for example, the first index column [1, 2, . . . , L] and the second index column [1, 2, . . . , L] are combined to generate a 2×L two-dimensional arrangement. Although the first and second index columns are the same index column in this example, the first and second index columns may be an arrangement of multiple indices which are different from each other.

When the process of step S3 is executed, the arrangement changing module 104 changes the arrangement of the parameters in the first parameter column extracted in step S2 and the arrangement of the indices in the first and second index columns generated in step S3 (step S4).

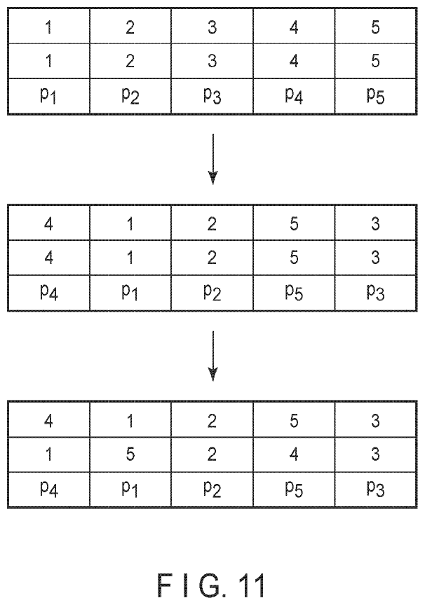

Here, FIG. 11 illustrates an example of the processing of step S4 (sequence changing processing for the first parameter column and the first and second index columns) described above. In FIG. 11, a case where the first parameter column extracted in step S2 above is [p₁, p₂, p₃, p₄, p₅] and the first and second index columns are [1, 2, 3, 4, 5].

In this case, in step S4, by randomly replacing the columns in the two-dimensional arrangement shown in the upper row of FIG. 11 (the two-dimensional arrangement generated by combining the first parameter column and the first and second index columns), the two-dimensional arrangement is converted into the two-dimensional arrangement shown in the middle row of FIG. 11.

Furthermore, in step S4, only the indices (columns thereof) in the second index column in the two-dimensional arrangement shown in the middle row of FIG. 11 are further randomly replaced to convert the two-dimensional arrangement to the two-dimensional arrangement shown in the bottom row of FIG. 11.

By separating the first parameter column and the first and second index columns from the two-dimensional arrangement shown in the lower part of FIG. 11, a first parameter column [p₄, p₁, p₂, p₅, p₃] the arrangement of parameters of which has been changed from the first parameter column [p₁, p₂, p₃, p₄, p₅], first index column [4, 1, 2, 3, 5] the arrangement of indices of which has been changed from the first index column [1, 2, 3, 4, 5], and second index column [1, 5, 2, 4, 3] the arrangement of indices of which has been changed from the second index column [1, 2, 3, 4, 5] are obtained.

The first index column whose arrangement was changed in step S4 corresponds to the information (parameter rearrangement information) indicating the correspondence between the arrangement before the change of the parameters in the first parameter column and the arrangement after the change of the parameters, as well as the index column of the first embodiment described above. On the other hand, the second index column whose arrangement was changed in step S4 corresponds to information indicating the correspondence between the arrangement before the change of the parameters in the first parameter column and arrangement which is different from the parameters after being changed, and is a dummy index column (dummy rearrangement information).

The process of step S4 described above using FIG. 11 is an example, and in step S4, it is sufficient to change the arrangement of the indices in the first index column as well as the index column in the first embodiment described above, and to change the arrangement of the indices in the second index column to a different arrangement from that of the first index column.

Next, the encryption unit 105 encrypts the first parameter column, the first index column, and the second index column obtained by executing the process in step S4 (step S5). The detailed explanation is omitted, but in this step S5, instead of encrypting the index columns as described in the first embodiment above, encryption of each of the first and second index columns should be performed. The processing of encryption of the first parameter column is the same as in the first embodiment described above. In other words, when the process of step S5 is executed in the present embodiment, N first parameter share columns, N first index share columns, and N second index share columns are generated.

After the processing of step S5 is executed, the N first parameter share columns, N first index share columns, and N second index share columns generated by the processing of step S5 are sent to the aggregated server device 20-1 to 20-N (step S6). In this case, one first parameter share column, one first index share column, and one second index share column are sent with respect to one aggregated server device.

In the present embodiment, the first parameter share column and the first and second index share columns are transmitted in different files. Furthermore, the first and second index share columns may be transmitted in different files.

Here, in the aforementioned first embodiment, for example, it is explained that the arrangement changing module 201 in the aggregated server device 20-1 changes the arrangement of the parameter shares in the first parameter share column (rearrangement of the parameter shares) based on the index share column transmitted from each of the client terminals 10-1 to 10-M. However, in the present embodiment, it is necessary to change the arrangement of the parameter shares in the first parameter share column based on the first index share column among the first and second index share columns. In other words, it must be noted that the aggregated server device 20-1 should refer to the first index share column when changing the parameter shares in the first parameter column.

Specifically, if the index share column to be referred to in repeated machine learning (i.e., the first index column to be referred) is fixed, it is sufficient if the reference to the first index column is set (specified) in advance in the aggregated server device 20-1 (to 20-N).

On the other hand, it is possible to have a structure in which the index share column to be referred to is changed for each repeated machine learning, and in this case, it is necessary to specify such index share column at each of the client terminals 10-1 to 10-M. The index share columns (indices for changing the arrangement) specified in this manner at the client terminals 10-1 to 10-M must be shared with the aggregated server devices 20-1 to 20-N (i.e., must be directed by aggregated server devices 20-1 to 20-N), but if, for example, the first and second index share columns are transmitted in the form of a two-dimensional arrangement from the client terminals 10-1 to 10-M, a file containing the row numbers of the two-dimensional arrangement indicating the specified index columns may be sent separately, or numerical values indicating the index share columns or the like may be inserted in the two-dimensional arrangement (e.g., fixed arrangement coordinate number).

The present embodiment should be configured such that the aggregated server device 20-1 to 20-N can grasp the index share columns to be referred to among the first and second index share columns, and there is no limitation on the method for specifying (sharing) the index share columns.

In FIG. 11 above, a case where the first index share column is used as an index for changing the arrangement is explained, but if the second index share column is specified as an index for changing the arrangement, only the multiple indices (columns) in the first index column in the two-dimensional arrangement shown in the middle row of FIG. 11 should be randomly replaced.

Hereafter, steps S8 to S13 described in the aforementioned first embodiment are executed. Note that, if the arrangement of the parameter shares in the first parameter share column is changed based on the first index share column in step S7 as described above, in step S9, the arrangement of the parameter shares in the second parameter share column is changed based on the first index share column. In addition, since the arrangement of the parameter shares in the second parameter share column is changed in step S11 based on the rearrangement information (first index column) of the plaintext parameters, there is no need to send the first index share column in step S10, but as with the first embodiment described above, if the parameter rearrangement information in the plaintext has been discarded at the client terminals 10-1 to 10-M, the first index share column may be sent together with the second parameter share column in step S10 to the client terminals 10-1 to 10-M. However, in this case, it is preferable to send the second index share column together with the first index share column.

As described above, in the present embodiment, each of the client terminals 10-1 to 10-M performs secret sharing with respect to the first index column indicating the correspondence between the arrangement of multiple parameters in the first parameter column (first arrangement) and the arrangement of multiple parameters that have been changed from the arrangement (second arrangement) in order to generates a first index share column (first fragment index column) corresponding to each of the aggregated server devices 20-1 to 20-N, and performs secret sharing with respect to the second index column which is different from the first index column in order to generate the second index share column (second fragment index column) corresponding to each of the aggregated server device 20-1 to 20-N. The first and second index share columns are sent to each of the aggregated server devices 20-1 to 20-N.

In the present embodiment, with such a structure, for example, even if k first parameter share columns among N first parameter share columns are obtained by a third party, and k first and second index share columns among N first and second index share columns are obtained by a third party, the third party cannot know which of the first and second index columns to be referred to for the rearrangement of the k first parameter share columns (multiple parameters in the first parameter column), and thus the possibility that the learning data be inferred from the multiple parameters can be reduced (i.e., improves safety in machine learning).

Furthermore, in the present embodiment, each of the aggregated server devices 20-1 to 20-N receives M first index share columns and M second index share columns transmitted from each of the client terminals 10-1 to 10-M, and changes the parameter share columns in each of the M first index share columns based on each of the preset M first index share columns among the M first index share columns and M second index share columns received.

In the present embodiment, with such a structure, even when a second index share column (dummy index column) is sent from the client terminals 10-1 to 10-M in addition to the first index share column as described above, the first parameter share columns sent from each of the client terminals 10-1 to 10-M can be properly aggregated in each of the aggregated server devices 20-1 to 20-N.

In the present embodiment, for example, the first parameter share column and the first and second index share columns are sent from the client terminals 10-1 to 10-M to the aggregated server devices 20-1 to 20-N in different files, and by adopting such a structure, for example, the first and second index share columns are obtained together with the first parameter share column, and the multiple parameters (arrangement thereof) in the parameter column decoded from the first parameter share column is prevented from being rearranged into the correct order.

In addition, in the present embodiment, the change of the arrangement of multiple parameter shares in the first parameter share column based on the first index share column (i.e., rearrangement operation) is performed by secure calculation, thereby reducing the amount of processing in each of the aggregated server devices 20-1 to 20-N because there is no need to perform the decoding process from the index share column.

In the present embodiment, the second index column is prepared (generated) as a dummy index column; however, there may be a plurality of second index columns. In this case, the multiple second index columns shall be changed to different arrangements. Specifically, for example, if the first parameter column whose arrangement is changed as in FIG. 11 is [p₄, p₁, p₂, p₅, p₃] and the first index column whose arrangement is changed is [4, 1, 2, 5, 3], the multiple second index columns whose arrangement is changed are, for example, [1, 5, 2, 4, 3] and [3, 4, 5, 2, 1], etc. Although the case where the number of second index columns is two is described here, the number of such second index columns may be three or more.

In addition, the present embodiment is described as preparing a dummy index column (second index column) in the structure described in the aforementioned first embodiment, but the present embodiment may also be applied to the aforementioned second embodiment (i.e., the present embodiment may be configured to prepare a dummy index column in the structure described in the second embodiment).

According to at least one embodiment described above, it is possible to provide a machine learning system and method which can ensure a high level of safety in machine learning.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine learning system comprising a plurality of client terminals and a plurality of aggregated server devices communicatively connected to the client terminals, wherein
each of the client terminals includes a first processor configured to:
execute a learning process of machine learning model using learning data managed in the client terminal;
extract a first parameter column in which a plurality of parameters are arranged from the machine learning model subjected to the learning process;
change the arrangement of the parameters of the extracted first parameter column;
perform secret sharing with respect to the first parameter column including the parameters with changed arrangement in order to generate a first fragment parameter column corresponding to each of the aggregated server devices; and
transmit the generated first fragment parameter column to the aggregated server devices, and
each of the aggregated server devices includes a second processor configured to:
receive a plurality of first fragment parameter columns transmitted from the client terminals;
change arrangement of fragment parameters of each of the received first fragment parameter columns; and
execute an aggregation process with respect to the first fragment parameter columns including the fragment parameters with changed arrangement in order to generate a second fragment parameter column, wherein
the machine learning model is updated based on a plurality of parameters in a second parameter column decoded from a plurality of second fragment parameter columns generated in the aggregated server devices.

2. The machine learning system of claim 1, wherein
the first processor is configured to:
determine, if the number of the aggregated server devices is N (N is an integer which is two or more), first coefficients r₁, . . . , rₖ₋₁ which are random numbers (k is an integer which is two or more and is N or lower, r₁, . . . , rₖ₋₁∈Q/qQ, Q/qQ may be constructed as the integers modulo q, Q is ring of integer) Q and second coefficients P₁, . . . , P_{N} which are random numbers (P₁, . . . , P_{N}∈Q/qQ) corresponding to N aggregated server device, and generate N first fragment parameter columns corresponding to N aggregated server devices based on k−1 degree polynomial formula where each of the parameters of the first parameter column is an intercept a, the k−1 degree polynomial formula is Σᵢ₌₁^{k-1}rᵢPⁱ+a, and
transmit each of the generated N first fragment parameter columns to the aggregated server device corresponding to the first fragment parameter column.

3. The machine learning system of claim 1, wherein the aggregation process is executed through secure calculation.

4. The machine learning system of claim 1, wherein
the first processor is configured to:
perform secret sharing with respect to an index column indicative of a corresponding relationship between a first arrangement of the parameters in the extracted first parameter column and a second arrangement of the parameters changed from the first arrangement in order to generate a fragment index column corresponding to each of the aggregated server devices; and
transmit the generated fragment index column to each of the aggregated server devices, and
the second processor is configured to:
receive a plurality of fragment index columns transmitted from the client terminals; and
change, based on each of the received fragment index columns, arrangement of the fragment parameters of each of the received first fragment parameter columns.

5. The machine learning system of claim 4, wherein the fragment index column is transmitted in a file which is different from that of the first fragment parameter column.

6. The machine learning system of claim 1, wherein
the first processor is configured to:
evaluate the machine learning model after the update using preset evaluation data; and
execute a learning process of the updated machine learning model after the update or the machine learning model before the update based on the evaluation result.

7. The machine learning system of claim 1, wherein
the first processor is configured to:
perform secret sharing with respect to a first index column indicative of a corresponding relationship between a first arrangement of the parameters in the extracted first parameter column and a second arrangement of the parameters changed from the first arrangement in order to generate a first fragment index column corresponding to each of the aggregated server devices, and perform secret sharing with respect to a second index column which is different from the first index column in order to generate a second fragment index column corresponding to each of the aggregated server devices; and
transmit the generated first and second fragment index columns to each of the aggregated server devices, and
the second processor is configured to:
receive a plurality of first fragment index columns and second fragment index columns transmitted from the client terminals; and
change arrangement of fragment parameters of each of the received first fragment parameter columns based on each of preset first fragment index columns of the received first and second fragment index columns.

8. The machine learning system of claim 7, wherein the first and second fragment index columns are transmitted in a file which is different from that of the first fragment parameter column.

9. The machine learning system of claim 4, wherein changing of arrangement of fragment parameters of each of the received first fragment parameter columns is performed through secure calculation.

10. A client terminal communicatively connected to a plurality of aggregated server devices, comprising a first processor configured to:
execute a learning process of machine learning model using learning data managed in the client terminal;
extract a first parameter column in which a plurality of parameters are arranged from the machine learning model subjected to the learning process;
change the arrangement of the parameters of the extracted first parameter column;
perform secret sharing with respect to the first parameter column including the parameters with changed arrangement in order to generate a first fragment parameter column corresponding to each of the aggregated server devices; and
transmit the generated first fragment parameter column to the aggregated server devices, wherein
each of the aggregated server devices includes a second processor configured to receive a plurality of first fragment parameter columns transmitted from a plurality of client terminals including the client terminal, change arrangement of fragment parameters of each of the received first fragment parameter columns, and execute an aggregation process with respect to the first fragment parameter columns including the fragment parameters with changed arrangement in order to generate a second fragment parameter column, and
the machine learning model is updated based on a plurality of parameters in a second parameter column decoded from a plurality of second fragment parameter columns generated in the aggregated server devices.

11. An aggregated server device communicatively connected to a plurality of client terminals, each of the client terminals including a first processor configured to execute a learning process of machine learning model using learning data managed in the client terminal, extract a first parameter column in which a plurality of parameters are arranged from the machine learning model subjected to the learning process, change the arrangement of the parameters of the extracted first parameter column, perform secret sharing with respect to the first parameter column including the parameters with changed arrangement in order to generate a first fragment parameter column corresponding to each of a plurality of aggregated server devices including the aggregated server device, and transmit the generated first fragment parameter column to the aggregated server devices, comprising a second processor configured to:
receive a plurality of first fragment parameter columns transmitted from the client terminals;
change arrangement of fragment parameters of each of the received first fragment parameter columns; and
execute an aggregation process with respect to the first fragment parameter columns including the fragment parameters with changed arrangement in order to generate a second fragment parameter column, wherein
the machine learning model is updated based on a plurality of parameters in a second parameter column decoded from a plurality of second fragment parameter columns generated in the aggregated server devices.

12. A method executed by a machine learning system including a plurality of client terminals and a plurality of aggregated server devices communicatively connected to the client terminals, the method comprising:
executing, by each of the client terminals, a learning process of a machine learning model using learning data managed in the client terminal;
extract, by each of the client terminals, a first parameter column in which a plurality of parameters are arranged from the machine learning model subjected to the learning process;
changing, by each of the client terminals, arrangement of the parameters in the extracted first parameter column;
performing, by each of the client terminals, secret sharing with respect to the first parameter column including the parameters with changed arrangement in order to generate a first fragment parameter column corresponding to each of the aggregated server devices;
transmitting the generated first fragment parameter column to the aggregated server devices;
receiving, by each of the aggregated server devices, a plurality of first fragment parameters transmitted from the client terminals;
changing, by each of the aggregated server devices, arrangement of the fragment parameters of each of the received first fragment parameter columns; and
executing, by each of the aggregated server devices, an aggregation process with respect to a plurality of first fragment parameter columns including the fragment parameters with changed arrangement in order to generate a second fragment parameter column, wherein
the machine learning model is updated based on a plurality of parameters of a second parameter column decoded from a second fragment parameter column generated in the aggregated server devices.
